(19) United States
(12) Patent Application Publication
(10) Pub. No.: US 2005/0143850 A1
(43) Pub. Date: Jun. 30, 2005

(54) Production machine comprising web server-integrated control

(76) Inventors: Rolf-Dieter Pavlik, Erlangen (DE); Gernot Rossi, Simmelsdorf (DE); Frank Volkmann, Nurnberg (DE)

Correspondence Address: Siemens Corporation;Intellectual Property Department, 170 Wood Avenue South, Iselin, NJ, 08830, US

(21) Appl. No.: 10/510,313

(22) PCT Filed: Mar. 26, 2003
(86) PCT No.: PCT/DE03/01007

(30) Foreign Application Priority Data
Apr. 2, 2002 (DE) 10214539.3

(51) Int. Cl. G05B 15/00

(52) U.S. Cl. 700/83; 709/219

(57) ABSTRACT

The invention relates to a production machine that comprises a web server integrated control, said web server comprising software modules and at least one first software module comprising first means for realizing the control.

### CROSS REFERENCE TO RELATED APPLICATIONS

This application is the US National Stage of International Application No. PCT/DE03/01007, filed Mar. 26, 2003 and claims the benefit thereof. The International Application claims the benefits of German application No. 10214539.3 filed Apr. 2, 2002, both of the applications are incorporated by reference herein in their entirety.

### FIELD OF INVENTION

The invention relates to a production machine with a control.

### BACKGROUND OF INVENTION

Production machines are typically used as plastic injection molding machines, packaging machines, textile machines, presses, machine tools and similar. Programmable Logic Controls are normally used for controlling production machines.

U.S. Pat. No. 6,061,603 A describes a control system which enables a user to reach a Programmable Logic Control via a communications network, for example the Internet, by means of a Web browser. The system contains an interface between the network and the Programmable Logic Control. This so-called Web interface provides Internet pages from an Ethernet interface of the Programmable Logic Control and contains an HTTP protocol interpreter and a TCP/IP stack (TCP/IP=Transmission Control Protocol/Internet Protocol). The Web interface thus offers a remote user access via the Internet to the Programmable Logic Control.

### SUMMARY OF INVENTION

The object of the invention is to demonstrate a non-proprietary option for solving the problem of implementing a control for a production machine.

This object is achieved with a production machine with a Web server-integrated control, where the Web server software module and at least one first software module feature first means to implement the control.

The invention is based on the knowledge that the classical world of automation currently has few points of contact with the Internet, since automation technology predominantly operates with proprietary protocols. However the development of Web technology is moving on with no regard to the problems of automation technology. Previous approaches, involving integrating separate Web server functionality into the automation components, are in their turn based on proprietary solutions for the individual components. The performance of these type of solutions has also proved very restricted. The production machine in accordance with the invention with a Web server-integrated control connects Web technology with automation systems in a surprising way in that an expansion module integrated directly into a Web server, as a rule a software module, provides the required automation or control functionality. The Web server is easily scalable and can thereby be used for controlling the components of one or more production machines, where the first software module for this features a connection to the production machine. A Web server expanded in its functionality in this way can process complex tasks of classical automation. Through the direct integration of the automation or control functionality into the Web server existing Web implementations can also be used in the processing of the automation task. Thus for example functions of the production machine such as remote maintenance, remote diagnosis, software update, production planning etc. can be executed with the aid of Web technologies. The control functionality of the production machine is integrated into the Web server to enable the latter's communication functions to be used.

By connecting the Web server with a communications network, especially the Internet, Internet technologies are made available to automation and also an end-to-end connection of the automation components to the communications network or the Internet is achieved.

The use of Internet protocols for communication between the software modules themselves and for communication between the software modules with components outside the Web server allows unity of the components of the Web server as regards their communications interfaces. The expansion of the Web server with further modules is made simpler since these modules can be used without expensive adaptation of proprietary protocols. Examples of normal Internet protocols are HTTP und FTP (File Transfer Protocol).

In an advantageous embodiment of the invention the Web server is provided for configuration and administration of the software modules.

In order to utilize available internet security mechanisms, it is proposed that the web server has a connection through a firewall to the internet. With regard to the already commonly encountered web server extension features integrated into an automation component, the security mechanisms required on the internet cannot as a rule be implemented on account of their tight requirements.

The connection of the Web server to a communications network, especially the Internet, can be used advantageously to support the automation functionality if the Web server is connected via a communications network to a Web browser as an operations and monitoring system for the automation system controlled by the first software module. This operating and monitoring system can also be used for project planning, for programming, for performing software updates, i.e. generally for data communication and data representation.

To also allow Web technologies to be used for real-time applications it is proposed that the Web server features a real-time operating system. Especially for use in process and production automation the automation components used must have real-time capabilities. By coupling the first software module to the real-time operating system this requirement can be fulfilled. The real-time operating system can also be used for a non-a real-time capable (part) operating system or as a standalone operating system.

The invention is described and explained below in greater detail on the basis of the exemplary embodiments shown in the Figures.

The figures show:

### BRIEF DESCRIPTION OF THE DRAWINGS

FIG. 1 a system with Web servers connected via the Internet which fulfill different tasks,

FIG. 2 a Web server with automation functionality for controlling a production machine and

FIG. 3 a schematic view of the structure of a Web server with automation functionality.

### DETAILED DESCRIPTION OF INVENTION

Servers which are connected to clients over the Internet and provide these with information, usually Internet pages, are called Web servers. Such a Web server is an application which runs distributed on one all more computers. Data which can be used by many different clients regardless of the relevant location of a client is stored centrally on the Web server. Both the software application running on a computer and also the computer itself are referred to as Web servers. Web servers are currently used as universal information providers in the Internet, but are also used in local networks based on Internet technologies. In such cases the option of expansion modules of the Web server is often used, for example to allow access to databases, forms etc. Communication between a client and a Web server is normally conducted in accordance with the HTTP protocol (HTTP=Hyper Text Transfer Protocol).

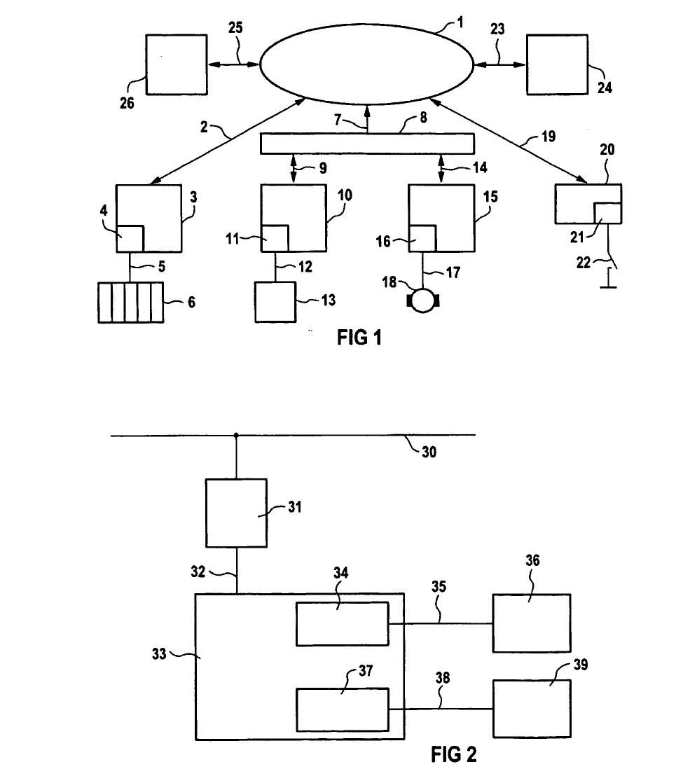

FIG. 1 shows various Web servers 3, 10, 15, 20, 24 which are connected to each other directly or indirectly via the Internet 1. A first Web server 3 communicates directly via a connection with the Internet 1. The first Web server 3 contains an expansion module 4 which is connected via an input/output module 6 of an automation system via a connection 5. A second and a third Web server 10, 15 are connected via connections 9, 14, to a firewall 8 and via a connection 7 to the Internet 1. The second Web server 10 features an expansion module 11 which has a connection 12 to a converter 13. The third Web server 15 contains an expansion module 16 which controls a drive 18 via a connection 17. The reference character 20 identifies a fourth Web server, a so-called embedded Web server which is connected directly via a connection 19 to the Internet 1 and features and expansion module 21 which controls a valve 22. The fifth Web server 24 shown in FIG. 1 does not have any automation functionality and communicates with the Internet via a connection 23. A Web browser 26 is connected to the Internet 1 via a connection 25.

The idea behind the invention will now be explained on the basis of FIG. 1. A Web server is a process on a computer—or also distributed over a number of computers—and usually supplies very many clients (Web browsers on different devices) with information. This Information can be located either statically on the Web server or can also be generated dynamically by further utility programs. Communication partners usually connected via the Internet 1 are thus Web servers in the embodiment of the fifth Web server 24 and Web browser 26. The fifth Web server 24 Provides information, in general Internet pages, at the request of a Web browser 26 via the Internet 1. The idea of the invention is now to embody such a standard Web server in such a way, by expansion using software modules that it can also deal with automation tasks, especially the control of production machines. The first Web server 3 contains an expansion module 4 which assumes the tasks of a Programmable Logic Control (PLC). The expansion module 4 as part of the Web server 3 is connected for this purpose via a connection 5 to an input/output module of an automation system. The first Web server 3 is thus not only used to provide information over the connection 2 into the Internet 1 but through the integration of the expansion module 4 can execute complex control tasks which with the prior art of technology were only able to be executed by self-contained Programmable Logic Controllers. A further exemplary embodiment of a Web server is shown in FIG. 1 in the second Web server 10 which features an expansion module 11 with CNC (CNC=Computer Numerical Controlled) functionality. The second Web server 10 controls a production machine, for example a computer-controlled machine tool (CNC machine tool) which is used for fast and accurate manufacturing of complicated turned and milled parts via the expansion module 11. These types of complicated controls are usually executed by computers specially designed for the task. A similar complex control task is control of a drive 18 which the third Web server 15 handles in the exemplary embodiment. To do this it contains an expansion module 16 which handles the demanding tasks of controlling or regulating the drive 18. In order not to waste the benefits of use of Web technologies through the second and third Web server 10, 15 through the disadvantage of lack of security, the Web servers 10, 15 are connected via a firewall 8 to the Internet 1. The firewall 8 effectively prevents illegal access via a communications connection to one of the Web servers and thereby to the drive 18 or the machine tool 13. In a further exemplary embodiment of the invention shown in FIG. 1 the Web server with automation functionality is a so-called embedded Web server 20 which contains as an expansion module 21, e.g. a temperature regulator for controlling a valve 22. This embedded Web server 20 is realized for example as a single-chip solution within a Personal Computer (PC). Each of the Web servers 3, 10, 15 or 20 described, in addition to offering the automation functionality of the expansion modules, also offers all the benefits of a standard Web server 24. The Web browser 26 connected via the Internet 1 can thus also access the Web servers 3, 10, 15 und 20 expanded with additional automation functionalities with Web technologies and can thus be used for example as an operation and monitoring system. The exemplary embodiments shown in FIG. 1 clearly show the better scalability of the solution proposed here compared with conventional approaches. The Web server can be implemented as a single-chip Web server with a hardware design (e.g. in the consumer area) through to a high-performance Web server SoftPLC and office software.

FIG. 2 shows an exemplary embodiment of a Web server with automation functionality for controlling a production machine as a schematic diagram. A Web server 33 is connected via a connection 32 and a TCP/IP stack 31 to a TCP/IP connection 30. The Web server 33 contains a first expansion module 34 which is embodied as a database module and has access via a connection 35 to an SQL server 36 (SQL=Structured Query Language). A second expansion module 37 has automation functionality and communicates via a connection 38 with a production machine 39. A production machine 39 is for example a plastic injection molding machine, a packaging machine, a textile machine, a press, in machine tool or similar. The expansion module 37, a software module, is coupled here via an interface not shown to connection 38 and thereby to the hardware components of the automation system for controlling the production machine 39. As front-end software, the TCP/IP stack controls the accesses to a network card not shown here which has access to the TCP/IP connection 30 and makes the TCP/IP protocol available the accessing processes.

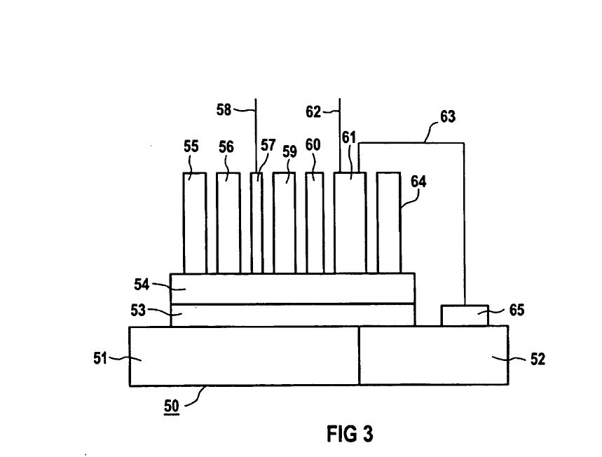

FIG. 3 shows the schematic view of the layout of a further exemplary embodiment of a Web server with automation functionality. The diagram shows software components of the Web server. An operating system 50 of the computer on which the Web server runs contains a standard operating system 51 as well as a real-time operating system 52. A Web server kernel 54 is used on the underlying operating system 50 by means of a porting 53. The Web server kernel 54 makes available standardized interfaces for linking in the software components and is the basis for various software expansion modules. A first expansion module 55 serves to provide Web pages, a second expansion module 56 serves as an XML parser. A Profibus connection 58 is connected to a third expansion module 57. A fourth expansion module 59 offers Java functionality, a fifth expansion module 60 processes signals from a Webcam. A sixth expansion module 64 is used for processing XML data. A seventh expansion module 61 with automation functionality features a connection 62 to a process and a connection 63 to an interface 65 to the real-time operating system 52. A system is deemed to have real-time capabilities if it can react within a nominal and guaranteeable time to random external events. In industrial automation systems reaction times in the microsecond range are usual and necessary. Real-time processes can use all services which are also available to other processes.

The operating system 50 has direct access to the resources of the computer, for example memory and computing time. If a command is issued or a program is called the necessary program code is loaded into a main memory and started as process. Processes have no access to the resources, they request these in each case from the operating system. The direct integration of the automation functionality as the seventh expansion module 61 into the Web server means that the power, the services (e.g. autotopology, SSDP, SNMP, e-mail etc.) and the openness of the Internet are made available to the world of automation and the other benefits described above are obtained. The seventh expansion module 61 on the one hand realizes the automation solution and on the other hand exchanges information via the Web server and is configured and administered by the latter. By contrast, with what is known as a SoftPLC (=software simulation of a Programmable Logic Control) the automation function is not integrated into the server but is installed in parallel with it, possibly linked via a communications interface. Integration into the server means in particular that the expansion module can be loaded, configured, started and ended directly by the Web server. This type of expansion module is frequently also referred to as an “extension”. The Web server kernel 54 of the Web server serves as a common platform for the expansion modules. This facilitates in particular the configuration of the software expansion modules and their re-use in other applications. The expansion modules are not linked in with proprietary or specially programmed interfaces but with standardized interfaces, for example API (Application Programming Interface) or CGI (Common Gateway Interface). API is a formally-defined interface via which the application programs can use system services (network, operating system etc.) or services of other application programs. CGI describes a standard interface between a Web server and programs. The seventh expansion module 61 features as a means for implementing an automation functionality regulation and/or control means for regulating and/or controlling components as well as processes of an automation system. These regulation and control means for controlling and automation system are usually embodied as executable software processes in the expansion module. The proposed Web server is part of a system of distributed applications constructed in a client-server architecture. In such a system it is the task of a server as provider of a service to undertake computations or other internal processes at the request of a client and to formulate their results as protocol-conformant responses and pass them on to the requesting client. A client here means a device or a process which makes use of the service of one or more servers. Normally the server makes a service available passively and waits for a client to submit a request to it. The client on the other hand does not provide any services itself that makes use of services from a server. A server as provider of a service can be located in this case on the same device as the client or on another device which can be accessed via a network (e.g. the Internet). Client-server communication obeys specific roles and formal descriptions, known as protocols. It is an indispensable requirement for successful communication between client and server that both sides use the same protocol. Such a protocol usually specifies the communication channels and the formats with their logon, information interchange, request, response and logoff. Not all of these-steps must always be explicitly specified if they are not of significance for the purpose of the application. Protocols are specified to a wide variety of levels of abstraction and usually build on each other. A layer model (e.g. ISO/OSI layer model) is then referred to.

While the lowest levels regulate communication of hardware and devices—electrical signals, cables or radio frequencies and their characteristics are specified, the middle layers deal with the structure of networked topologies (address structures and their resolution, routing and error correction). The network layer (e.g. IP=Internet Protocol) and the transport layer (e.g. TCP=Transmission Control Protocol) are often differentiated here. The topmost levels are referred to as the application layer. This specifies in concrete terms how client-server applications communicate with each other. Examples of such protocols of the application layer are HTTP (Hyper Text Transfer Protocol), FTP (File Transfer Protocol) and SMTP (Simple Mail Transfer Protocol).

In summary the invention relates to a production machine 39 with a control integrated in a Web server 33, where the Web server 33 features software modules 34, 37 and at least a first software module 37 features first means to implement the control.

1-7. (canceled)

8. A production machine comprising a control integrated in a Web server, wherein the Web server comprises software modules, and wherein at least a first software module comprises first mechanisms to implement the control.

9. The production machine according to claim 8, wherein the Web server comprises a connection with a communications network.

10. The production machine according to claim 9, wherein the communications network is the Internet.

11. The production machine according to claim 8, wherein Internet protocols are provided for communication between the software modules and for communication between the software modules and components outside the Web server.

12. The production machine according to claim 9, wherein Internet protocols are provided for communication between the software modules and for communication between the software modules and components outside the Web server.

13. The production machine according to claim 8, wherein the Web server is adapted for configuring and administrating the software modules.

14. The production machine according to claim 9, wherein the Web server is adapted for configuring and administrating the software modules.

15. The production machine according to claim 11, wherein the Web server is adapted for configuring and administrating the software modules.

16. The production machine according to claim 8, wherein the Web server comprises a connection to the Internet via a firewall.

17. The production machine according to claim 9, wherein the Web server comprises a connection to the Internet via a firewall.

18. The production machine according to claim 11, wherein the Web server comprises a connection to the Internet via a firewall.

19. The production machine according to claim 13, wherein the Web server comprises a connection to the Internet via a firewall.

20. The production machine according to claim 8, wherein the Web server is connected via a communications network with a Web browser as operating and monitoring system.

21. The production machine according to claim 9, wherein the Web server is connected via a communications network with a Web browser as operating and monitoring system.

22. The production machine according to claim 11, wherein the Web server is connected via a communications network with a Web browser as operating and monitoring system.

23. The production machine according to claim 13, wherein the Web server is connected via a communications network with a Web browser as operating and monitoring system.

24. The production machine according to claim 16, wherein the Web server is connected via a communications network with a Web browser as operating and monitoring system.

25. The production machine according to claim 8, wherein the Web server comprises a real-time operating system.

26. The production machine according to claim 9, wherein the Web server comprises a real-time operating system.

27. The production machine according to claim 11, wherein the Web server comprises a real-time operating system.
